(19) United States
(12) Patent Application Publication
(10) Pub. No.: US 2008/0008295 A1
(43) Pub. Date: Jan. 10, 2008

(54) METHOD OF PROVIDING ADVERTISEMENT VIA TELEPHONE MOBILE PHONE WITH USER REQUEST

(76) Inventor: R. Sivakumar, Tamil Nadu (IN)

Correspondence Address: BROOKS KUSHMAN P.C., 1000 TOWN CENTER, TWENTY-SECOND FLOOR, SOUTHFIELD, MI, 48075, US

(21) Appl. No.: 11/768,639

(22) Filed: Jun. 26, 2007

Related U.S. Application Data
(63) Continuation of application No. PCT/IN05/00414, filed on Dec. 15, 2005.

(30) Foreign Application Priority Data
Dec. 28, 2004 (IN) 615/CHE/2004

(51) Int. Cl. H04M 1/64

(52) U.S. Cl. 379/67.1

(57) ABSTRACT

A system and method of providing advertisements to telephones and mobile phones during the set up of a call connection in a program controlled telephone exchange system includes the following steps: (1) storing advertisements corresponding to profiles for various phone users; (2) providing the advertisement feeds upon the consent of the phone call initiator over the phone when requested by the telephone exchange; (3) identifying the caller and selecting a suitable advertisement from on-line/off-line server; and (4) connecting the on-line server inport source to an Internet site and an output source to the telephone exchange via advertisement and playback circuit.

### CROSS-REFERENCE TO RELATED APPLICATIONS

This application is a continuation of PCT Application No. PCT/IN2005/000414, filed Dec. 15, 2005 which claims priority to Indian Application No. 615/CHE/2004, filed Dec. 28, 2004.

### FIELD OF INVENTION

This invention relates to a method adopted to transmit advertisement is purely depends on the choice of telephone/mobile phone call initiator. The call initiator can either receive the advertisement before connect the other terminal or directly communicate to other terminal with out advertisement. When the call initiator wants to receive the advertisement, he/she has to dial the ‘advertisement request code’ followed by the number he/she is calling. In case caller dials the phone number with out using ‘advertisement request code’ the exchange will connect the call directly with out advertisement. The caller will receive incentive/discounts for opting/listening the advertisement. At the same time this invention gives a marketing opportunity directly to the advertisers.

This system/concept is unique, for it is only of its kind of advertising through phones, to a maximum reach of every individual customers by the advertisers and in turn the call initiators will get incentives for opting/listening the advertisement before connecting the call. Advertisers can play their advertisements in audio, video formats according to the call initiators.

### PRIOR ART

One of the existing service for providing advertisement information via a telephone provides a caller with one or more piece of advertisement information via a telephone net work and also a server for providing advertisement information. This method transmits to the user at least one piece of advertisement from a plurality of pieces of advertisement information. E P patent documents EP 1198114 teach this technology.

The telephone communication is not an entertainment media like TV, Radio etc . . . the telephone communication is a useful media of communication between users to transfer their information. The most important feature of any product or service offered in the market scenario is letting the customer have the most flexibility and choice over the product/service. A rigid and non-flexible system will not be preferred by all segments of the customer group.

The existing system disturbs the customer as it transmits at least one piece of advertisement information to the caller when connecting the call. This will disturbs and affect the freedom of the caller during an emergency call or if the user feels it is totally unnecessary at that particular moment. The caller make emergency call to hospital or air port or any part then advertisement information is transmit his phone, he/she has fully disturbed and irritated.at the same time no more opportunity give to the advertiser directly.

### OBJECT OF INVENTION

The option offered to the phone user to opt for the advertisement or route the call directly. This facility will enable the call dialer to not waste time during an emergency call and the dialer feel it is totally unnecessary at the particular moment. At the same time this invention gives a marketing opportunity directly to the advertisers.

This invention is to make advertisers to benefit at a large by making the every individual personal attention, which is actually missing in this modern world. Moreover this invention will encourage the advertisers and phone users to use the phone at maximum and this will bring down the phone cost, advertisement cost, as a whole the telecommunication will develop at greater speed. The call initiators are benefited by reduction of call cost and the valuable time of human beings is reduced which will improve the countries economy.

Novelty:

A method of providing advertisements through tele/mobile phones with out disturbed the phone users, and getting a marketing opportunity directly to the advertisers. A method adopted to transmit advertisement is purely depends on the choice of telephone/mobile phone call initiator. In this invention user makes a call with receive advertisement, then he/she dial the phone number with ‘advertisement request code’. Then he/she receive the advertisement via telephone exchange/Mobile Switching Centre from the server. In this method if the users receive the advertisement, they would get incentive. If they would not receive the advertisement, no more get incentive.

Normally the advertisements are advertised through television, radio and newspaper which increases the cost of advertisement for the advertisers and the advertiser keep the advertisement cost on their products. In my novelty the advertisements are reaching large people and the advertisement cost are reduced and the individuals are not forced to listen to advertisements in turn they are listening to the advertisement with pleasure which will given them a substantial reduction of call cost. The advertisers are advertising the products according to their range of customers. The maximum call initiators are encouraged and the cost of calls is reduced; advertisement cost is reduced; growth in telecommunication; economy growth and employment are increased.

### SUMMARY

This method adopted to transmit advertisement is purely depends on the choice of telephone/mobile phone call initiator. This method makes freedom, hope and joy to the phone users. However many time users would receive the advertisement and get concession rate of call cost from advertisers. Any time users make the call emergency for hospital, air port, office etg . . . then they will make the call with out advertisement and would pay their own cost.

When caller wanted to receive the advertisements then the exchange transmit the advertisement from the server to the caller and after the completion of advertisement the exchange to connect the opposite terminal. And when caller will not wanted to receive the advertisements, and then he will communicate immediately to other terminal with out advertisement. However they dial to the tele/mobile phone number with ‘advertisement request code’ then the exchange/mobile switching centre will doing this process. The caller dial to the tele/mobile phone number with out ‘advertisement request code’ then the exchange/mobile switching centre will doing the actual call process with out advertisement. When caller chose to receive the advertisement then he would get the incentive.

In this invention alternative method of providing advertisements, callers dial to the tele/mobile phone number with out ‘code’ then the exchange/mobile switching centre will doing this process. The caller dial to the tele/mobile phone number with ‘code’ then the exchange/mobile switching centre will doing the actual call process with out advertisement.

Some times caller wanted repeat to receive the advertisement. Then he dial the ‘repeat request code’ after completion of advertisement or call connection or between communicate to other terminal. The exchange/mobile switching centre receive this ‘code’ from caller then sends to the advertiser's page via server. This process helps to a marketing opportunity for advertisers.

Some times caller wanted to buy the advertisement product. Then he dial the ‘buying request code’ after finishing of advertisement or call connection or between communicate to other terminal. The exchange/mobile switching centre receive this ‘code’ from caller then sends to the advertiser's page via server. This process helps to a marketing opportunity for advertisers.

In this invention advertisement request code, repeat request code and buying request code means any key button or buttons of tele/mobile phone hand set.

Normally the advertisements are carried out for reaching large number of customers through televisions, newspapers, banners & pamphlets which will not reach an appropriate consumer who really need of it for i.e If a textile show room wants to advertise its range of products to a consumer whose earning capacity is at the rate of 20,000/—who can spend for arrow pants that cost around 1200 to 1800. The textiles show room no needs to spend more time on television & banners by spending more. If the show room textile owner advertises through my invention (advertisement through telephones, cell phones and mobile phones) he can reach the particular group of customers alone and the advertisement is restricted to the particular product to a particular range of customer with better options.

The invention has made with great effort to provide the requirement of the advertisement industry and over come the problem of high expenditure spent on advertisement; and encourage the utility of telecommunication at large.

The existing advertisement is nothing but advertisement at higher rate paid to the medias and the advertisement are not reaching the proper people.

At the outset of the description that follows, it is to be understood that ensuring the description illustrates only the particular form of this invention. However such particular form is only exemplary embodiment without intending to imply any limitation on the scope of the invention. Accordingly the description is to be understood as an exemplary embodiment and the invention not to be taken restrictively on reading.

The forgoing description outlined is rather broadly preferred alternative feature of the present invention. So that one skilled in the art may better understand the detailed description of the invention that follows.

Additional feature of the invention will be described hereinafter that form the subject of claims of the invention. Those skilled in the art should appreciate that they can readily use the disclosed consumption and specific embodiment as a basic for designing and modifying other structure for carrying out the same purpose/concept of the present invention.

Those skilled in the art should realize such equivalent consumption do not depart from the spirit and scope of the invention in its broadest form.

As per the requirement of the telephone connection, the advertiser circuit and the audio outputs and the relay system are replaced to the required condition.

Now the invention will be described detail in the following description.

The nature of the invention and the manner in which the invention to be performed are clearly described in the following description.

The diagram of the circuit of the invention (advertisement circuit) mc Board and the process of steps involved in advertising and billing in the said invention is shown in the circuit accompanying the specification.

### BRIEF DESCRIPTION OF THE DRAWINGS

FIG. 1 is a block diagram illustrating a system for providing advertisement via telephone/mobile phone according to one embodiment of the present invention;

FIG. 2 is a schematic diagram showing main exchange control board circuits according to one embodiment of the present invention;

FIG. 3 is a schematic diagram showing color line identification protocol circuits according to an embodiment of the present invention;

FIG. 4 is a schematic diagram showing a cross bar relay circuit according to an aspect of the present invention;

FIG. 5 is a schematic diagram showing an advertisement circuit according to an embodiment of the present invention;

FIG. 6 is a schematic diagram showing an audio recorder and playback circuit according to an embodiment of the present invention; and

FIG. 7 is a block diagram illustrating communication links various databases according to an embodiment of the present invention.

### DETAILED DESCRIPTION OF THE INVENTION

Telecommunication Company includes landline phone, cell phone, mobile phone & wireless phone (WLL)

This invention involves three categories of people the (1) telecommunication company including landline, cell phone, mobile phone, wireless phone (WLL) (2) advertisers, (3) users public/call initiators.

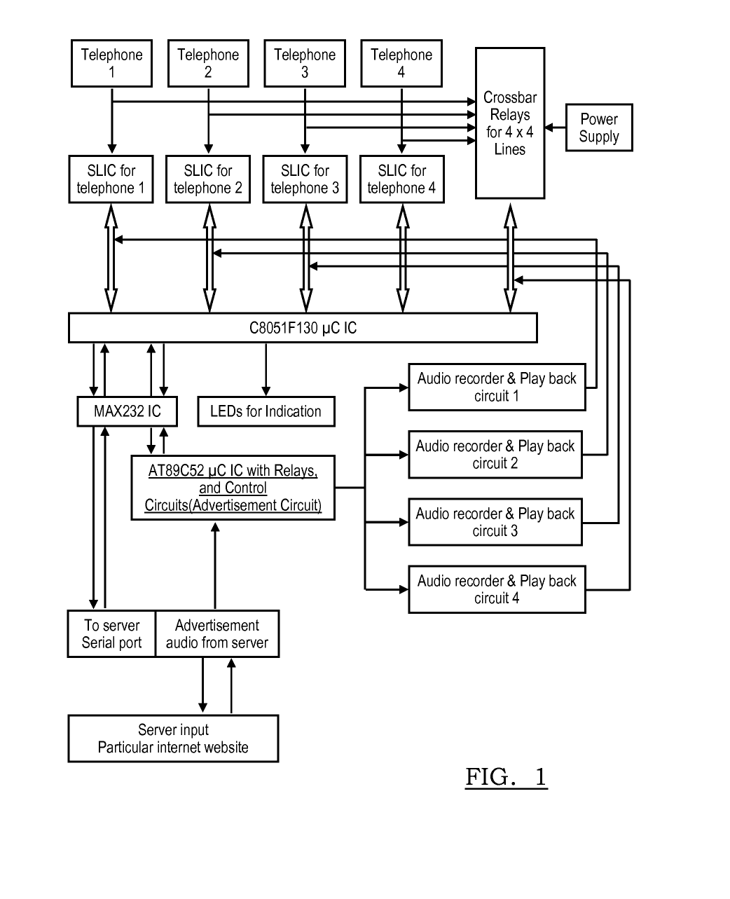

FIG. 1 is the total block diagram includes main exchange, CLIP, cross bar relay, advertisement circuit, audio recorder & play back circuit, 4 phone line and pc server as like (online/off line) server.

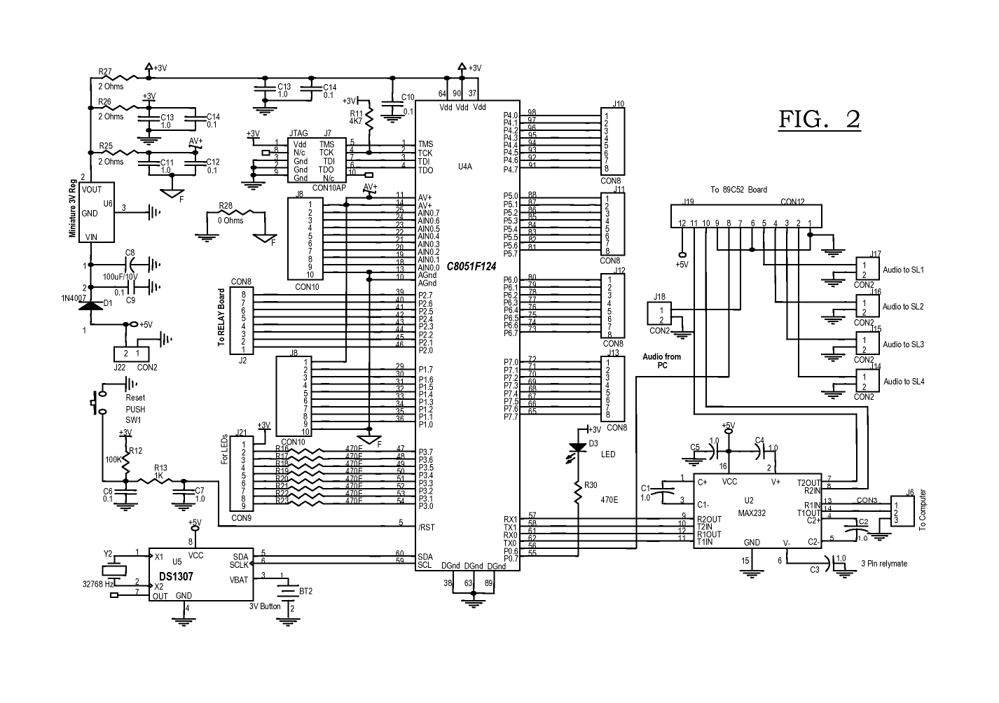

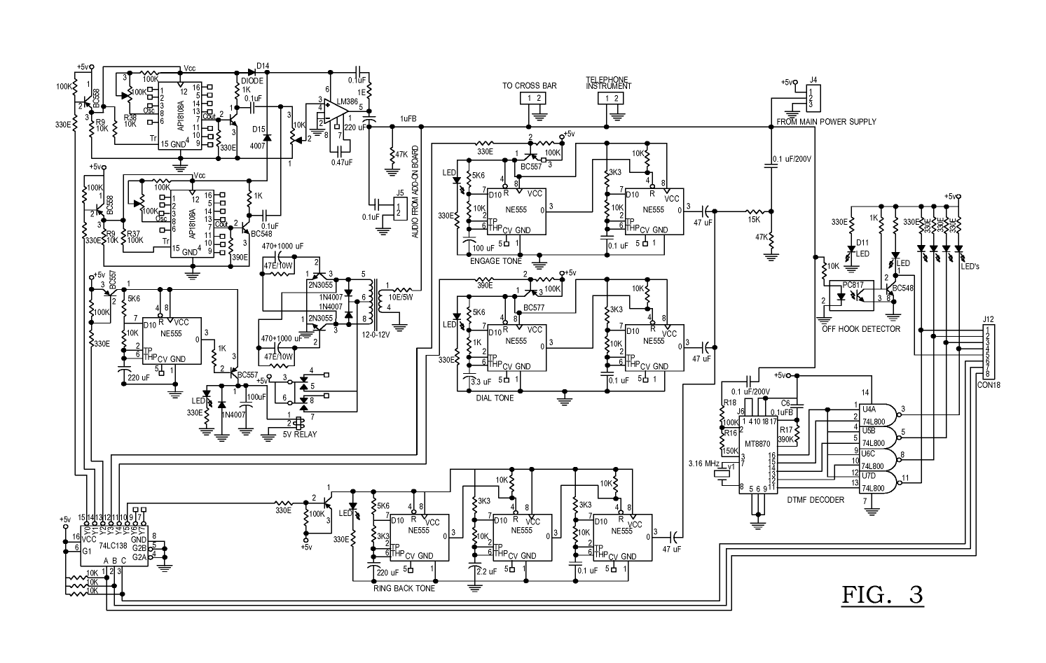

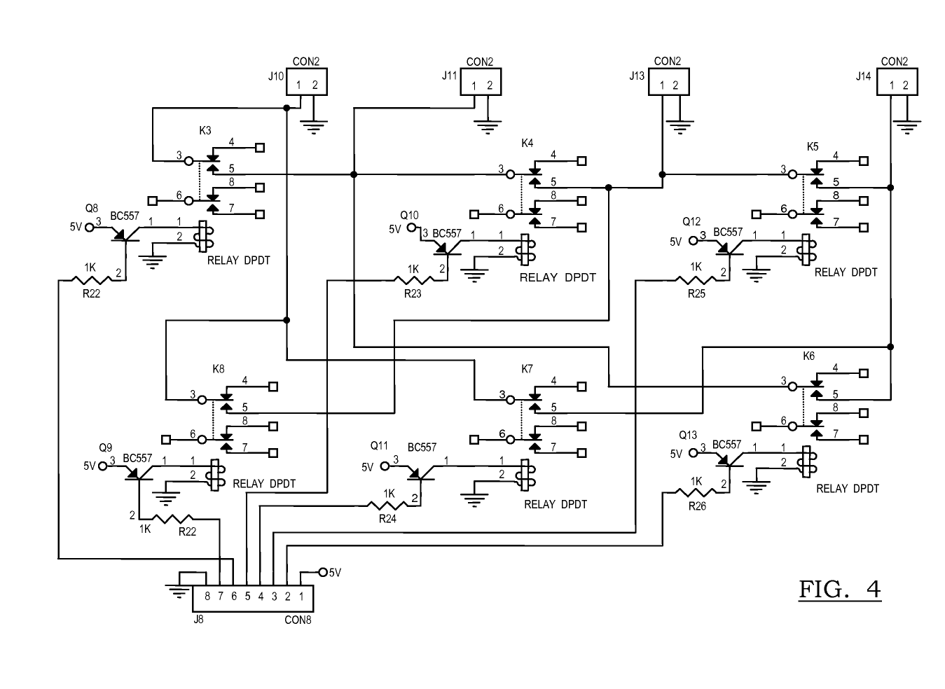

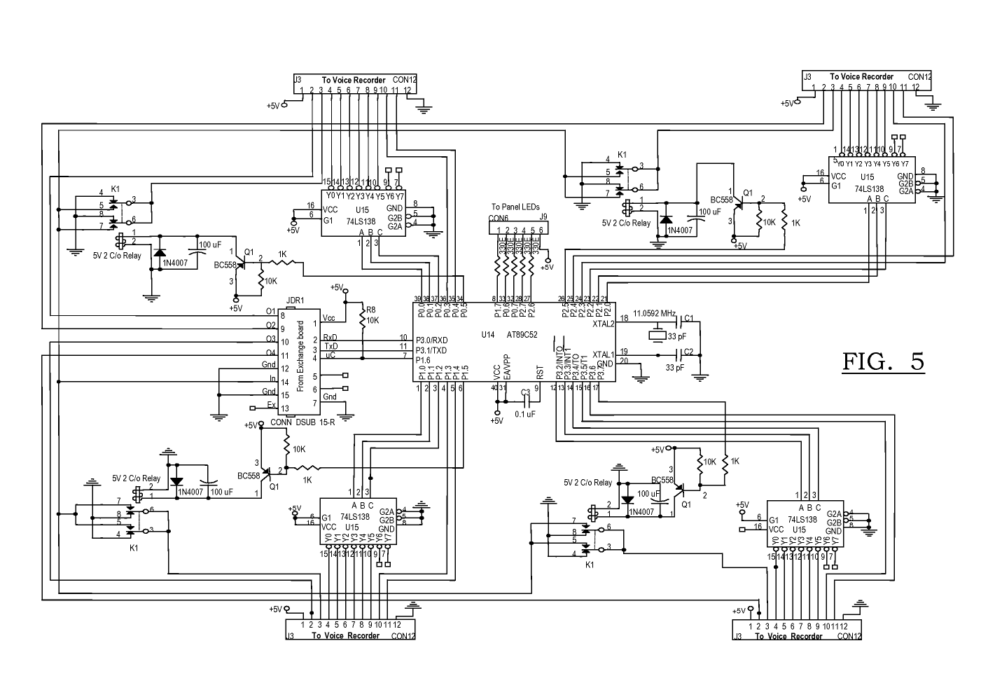

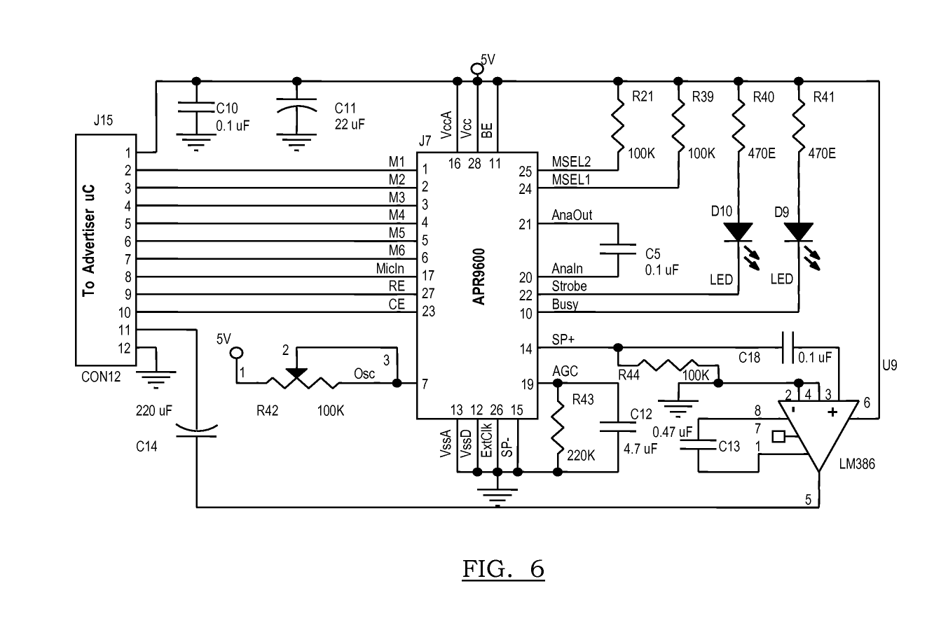

The protocol circuits are placed FIG. 2 main exchange control board circuits, FIG. 3 caller line identification protocol circuit, FIG. 4 cross bar relay circuit, FIG. 5 advertisement circuit mc board, FIG. 6 audio recorder & play back board circuit. FIG. 2 is the micro controller of the board that operates the telephone exchange. This micro controller also talks to the server (server with advertisers MP3 & user profile) This Board contain the main power supply parts as well as connectors to other boards. Slic rely mate connectors used for serial communication to computers through post and pins are used to communicate with micro controller of advertisement circuits. Connector carries audio input to advertiser circuit, at audio outputs to telephone users, power for the advertiser circuit and other controls pins needed.

This micro controller will analyze the signal on the connector to know whether the advertiser board is connected. If the advertiser board is not connected the telephone exchange will function as a normal telephone exchange. If the micro controller sense that the advertisement circuit is connected, then it will inform the advertisement circuit wherever the telephone users dials ‘*’/any advertisement request code and dials telephone number to call, then the advertisement circuit play the advertisement audio and on end of advertisement audio the regular connection procedure is initiated by the telephone exchange.

The FIG. 3 in the CLIP (caller line identification protocol) is used as an interface between telephone instrument and the telephone exchange micro controller. Powering the telephone line is necessary, the telephone line is connected to this circuit and also to the cross bar relay circuit the main function of CLIP circuit is to sense the handset is (on) in case of cellular phones and other phones and in case of land line telephone the handset is placed on instrument cradle or lifted. This information is sent to the telephone exchange micro controller.

The CLIP circuit also has ringer circuit, ring back tone generator; engage tone generator, voice message circuit & additional voice message circuit if the caller is not having the advertisement facility. The telephone exchange processes can bigger CLIP to send and if the above.

FIG. 4 is the cross bar relay circuit of the protocol type. This cross bar relay circuit is used to make connection between two-telephone instruments. This board is totally under the control of the telephone exchange micro controller I.C.

FIG. 5 shows the Advertisement circuit micro controller board. This is the brain on board for advertisement circuit. These boards communicate with the telephone exchange, to know whether advertisement audio is to be played for a particular caller/call initiator, the computer server informs the micro controller that the next audio for a particular caller is waiting, and then it directs the particular audio from computer to play circuit for recording/play. The output from each audio board/play circuit is connected to a particular caller and the audio message is fixed for particular time and the micro controller operates/terminates the audio play. The computer server ensures the audio playtime.

FIG. 6 shows the audio recorder and playback device circuit. The audio recorder play back device is configured in random access mode. The device capacity varies according to the need. The message trigger are trigged by micro controller from advertiser circuit for play a particular message stored in its memory (at this point RE pin will be high & CE pin will be low.

The message can be selected randomly.

For recording the message, the micro controller make CE & RE pin low & select the message location and speaker shown is replaced by wire connection to the telephone line to which this is connected. This can store and record message i.e. advertisement.

From the above detailed explanation we can understand that the circuits used in advertisement through telecommunication (Hardware). The block diagram would have illustrated the working of the invention for better understanding, which is the combination of software and hardware. The software process is the data base which consists of the following (i) user registration, (ii) advertiser, (iii) mp3 files, (iv) details about the advertisement heard by the caller, (v) storing telephone user profile, (vi) current users and (vii) location of the call initiators and advertisers.

The telephone user are registered categorically i.e. by age, income, sex and other mean and the details are stored in the computer server which is connected or linked to the telephone exchange. The advertisers are also registered and stored in the server in a different profile categorically i.e. based on nature of business, goods/products/service and customers. The mp3 player is nothing but number of advertisements stored in a single file/disc, which can be played according to the call initiators and advertisers. Another profile is created for storing the details of the advertisement heard by the call initiators; numbers of times heard/played for bill deduction are stored. Telephone user profile is nothing but the number of telephone user opted for this type of billing.

New Process Details:

The telephone exchange micro controller sends one byte of data indicating the telephone line number using this byte. The operation is timed and will last for about 10 seconds. In case the advertisement is short of 10 seconds, the computer server, where the audio is stored is padded with some music to make all advertisements to last about 10 seconds. This method is chosen to minimize the overhead of the exchange.

In reality, the exchange circuit will not be burdened with complex protocol and only 2-byte protocol at the proposed speed on 1 mbps will be used. This protocol will demand only 5 ms of exchange time for triggering an audio feed. If 1,000 lines are to be servile with audio feed at any given time, only about 10 ms will be time demand on the exchange.

In future, powerful micro controller can be used for advertisement board with audio processing capability and powerful server with many processors parallel for extremely efficient operation in real time. In reality, only micro server per telephone line for request of audio feed in the time demand on the exchange, which is tolerable by any standard.

In this method Mobile Switching Centre can do the telephone exchange's process.

After playing the audio for about 10 seconds, the advertiser circuit micro controller sends the coded signal it received from the telephone exchange as indication of completion of task on the particular phone line. The telephone exchange takes Control over the phone line and continues the processing of completion of call procedures as if the call was initiated at that instant. In the present implementation, the telephone exchange processors will talk to both computer server and advertisers circuit to implement the audio feed technique.

The procedure adopted to play an advertisement audio depends purely on the discretion of telephone call initiators. The caller indicates his intentions to receive audio feed by dialing *(advertisement request code) followed by the number he is calling. In case caller dials the phone number without using * the exchange will not alert advertisement circuit and act on its own to complete the connection process.

Some times caller wanted repeat to receive the advertisement. Then he dial the ‘repeat request code’ after completion of advertisement or call connection or between communicate to other terminal. The exchange/mobile switching centre receive this ‘code’ from caller then sends to the advertiser's page via server. This process helps to a marketing opportunity for advertisers.

Some times caller wanted to buy the advertisement product. Then he dial the ‘buying request code’ after finishing of advertisement or call connection or between communicate to other terminal. The exchange/mobile switching centre receive this ‘code’ from caller then sends to the advertiser's page via server. This process helps to a marketing opportunity for advertisers.

Some times caller wants to receive the advertisement particular regular calls. Then she/he would make just one time the advertisement request regular ON code. However the caller dial the ‘advertisement request regular ON code’ (ie *50) to the exchange/mobile switching centre, then the exchange/mobile switching centre, receive and register it and continue transmit the advertisement before call connecting without making ‘advertisement request code’ every time she/he has calling.

Some times caller wants to make the calls without advertisements particular regular calls. Then she/he would make just onetime to the ‘advertisement request regular OFF code’ (ie *51) to the exchange/mobile switching centre.

However the caller dial the ‘advertisement request regular OFF code’ to the exchange/mobile switching centre. Then the exchange/mobile switching centre receive and register it and continue to connect the call directly without advertisements every time she/he has calling.

In this invention ‘advertisement request code’ repeat request code’, Buying request code’ ‘advertisement request regular ON code’ and ‘advertisement request regular OFF code’ means any key button or buttons of the tele/mobile/cell phone hand set.

This criterion meets the part of the essence of the invention being specification, to play/transmit/relay advertisement audio/video or multimedia signals in any playable format using phone to the user who has indicated his/her willingness to take such advertisement before initiating the call. The computer, which acts as (online/offline) server will have the appropriate screens for interfacing with phone user, advertiser and the operator (inventor). The operator has total control over the computer server that is hooked to a hardware circuit (explained above in advertisement circuit). The hardware circuit talks to telephone exchange/Mobile Switching Centre as well as computer server. The computer server communicate with the hardware circuit only when hardware tells the computer that it had just plays an advertisement to a caller and the computer server may send a new advertisement to it. All communications are initiated by hardware and computer server only responses as per the requirements.

Brief Process

The hardware is triggered by the telephone exchange when the caller dials ‘*’(advertisement request code) followed by the telephone number of the person he wishes to contact. The advertisement circuit takes control of the telephone user line from telephone exchange and plays out the advertisement to that particular caller/call initiator/telephone user. After completing the advertisement, the advertisement circuit passes the control of the telephone line back to the telephone exchange. The advertisement circuit now sends a signal to computer server giving the telephone number of the user who had just requested and listened to the advertisement. The computer software now marks the mp3 in that user database as played and upgrades the incentive points obtained by that telephone user/caller/call initiator.

When call dial the ‘Buying request code’ after completion of advertisement or in-between the communication, then the exchange send this message to server. Server receive this message from the exchange and stored it to the advertiser's page.

How Each Phone User Gets Advertisement Played on his Phone, Suitable for His Interest?

MP3/any audio format Database is a connective link between phone User and Advertiser.

Each telephone user's details are maintained in common Database like Userreg Database. A database for each Telephone User (User n) is created in which the most suitable Advertisement IDs for that particular user is stored. For this project, we use common database as Userreg Database and each individual database as User1, User2, User3, and User4

The following are the sequence of event when a new telephone user registers with our database.

When New Telephone user registers for the first time on the web, his profile details are stored on Userreg Database.

Then the registered Telephone User's profile is matched with each advertisement profile in MP3 Database.

The program calculates points (marks) for each advertisement, based on, exact match to approximately match or maximum match to minimal match with relevance to Telephone User's profile. However, that advertisement point should not be below 4. At least one item should match for inclusion in database.

Note about Points:

Each advertisement has target customer settings i.e., the advertiser can choose to whom the advertisement should be played. Advertiser is presented with the profile sample of a telephone user. The software now compares the profile settings for each MP3 with the profile of the telephone user. There could be 100% match or matching in few areas only. Each item in the profile is given a grade or mark and if that item in MP3 matches with the item of profile of the telephone user, then the points are added to MP3 for that telephone user.

The software now creates User n database for this particular phone user. Match his profile settings with all MP3s. If at least one match occurs, then the MP3 ID is included in User n database with its corresponding match points. The MP3 IDs are arranged in descending order of value of matching points.

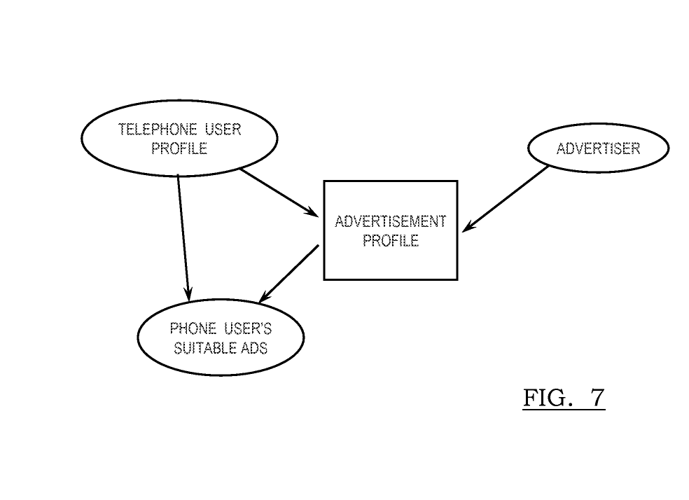

The above process is repeated every time Advertiser Loads a new MP3 or edits profile settings for advertisement MP3. For each Tele user registration or each new MP3 load or Edit of profile for present MP3 by an advertiser will automatically result in updating User n database. The FIG. 7 flow diagram explains this process.

The Advertiser also follows a similar procedure when he registers for the first time. He loads his company details and loads MP3 advertisement files. He will choose the items in profile for which the MP3 should be played.

He can choose all items of profile meaning this Advertisement can be played to any telephone user. He can choose geographical location of the telephone user to whom the advertisement should be played.

The MP3 is selected for testing. This MP3 will be played and listened by an official of the organizer, for making sure that the MP3 does not contain any obscene or unlawful material. After clearance from the official, this MP3 is added to MP3 database.

The software now matches the items of profile of the MP3 with the profile of a telephone user. The matching points of that MP3 for that Tele user are now calculated.

After calculating the advertisement points for MP3 for a particular telephone user, the User n database is updated and rearranged.

The order in which the MP3 ID is stored in User n database determines the priority of playing advertisement to that telephone user.

When the hardware (Advertisement Circuit) ask for next advertisement to be played for a particular telephone user, the software selects the top most MP3 ID to be played next, from User n database and sends this advertisement to hardware.

When the Hardware has played the MP3, it sends a signal to PC indicating the telephone user for whom the Advertisement is played. PC reads the date and time from its internal clock and updates User n database. The PC software now sends the next MP3 to hardware and indicates to hardware the telephone user for whom the MP3 should be played next time.

Advertiser can log in, see to whom all the MP3s have been played, and generate appropriate report for his need.

Tele users can log in and see the advertisements he had heard so far and the points that have been allocated to him for having asked for and listened the advertisements. The phone user can also send e-mail to a particular advertiser or make a note of advertiser/s contact details.

The facility to contact between advertiser and telephone user is the important point that will result in increased sales for advertiser and increased customer satisfaction for phone user.
Advertiser UPLOADS an Advertisement Mp3

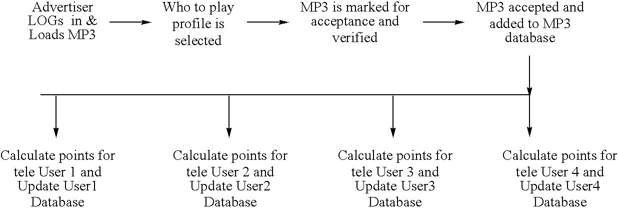

An Advertiser can load any number of Advertisement MP3s at any time; but only five of them will be set as active. Each advertisement is played and cleared by an official. This MP3 is added to list and advertiser can activate it whenever he wants it. The software will send the MP3 as and when the request comes from the Hardware circuit. Advertiser has also the authority to change the profile details of an MP3 and the points for each telephone user are recalculated and the User n database is automatically rearranged.

Implementation

The implementation of one part for phone user for phone User Registration, Edition, and views of their points. In the second part for Advertiser, Advertiser Registration, Edition, Loading Advertisements, alter profile items for a particular MP3, view the details about whom all had heard the advertisements and detailed report. The third part is the communication between PC server and Hardware. The advertiser may contact the phone user if he has agreed for such contacts and Telephone user can contact advertiser for obtaining service. This service is possible if the telephone user and advertiser had given their e-mail ID for communication.

The PC, which acts as server will have the appropriate screens for interfacing with Telephone user, advertiser and the operator. The operator has total control over the PC server that is hooked to a hardware circuit (Explained in detail at the hardware Documentation as Advertisement Circuit). The hardware circuit talks to Telephone exchange as well as PC server. The PC server communicates with Hardware circuit only when hardware tells the PC it had just played an advertisement to a telephone user and PC server may send a new advertisement feed to it. All communications are initiated by Hardware and PC server only responds as per requirement.

Explanation of Communication Between Server and Hardware:

When Hardware indicates it had just finished playing an advertisement to a particular Telephone User, it sends a data request signal (code). The hardware is triggered by the telephone exchange when the telephone user dials ‘*’ followed by the telephone number of the person he wishes to contact. The Advertisement circuit takes control of the telephone user line from telephone exchange and plays out the advertisement to that particular telephone user. After completing the advertisement, the Advertisement Circuit passes the control of the telephone line back to the telephone exchange. The Advertisement circuit now sends a signal to PC server giving the telephone number of the user who had just requested and listened to the advertisement. PC software now marks the MP3 in that USERn database as played and upgrades the incentive points obtained by that telephone user.

PC now gets ready to send an advertisement to Advertisement Circuit. The Hardware now readies itself and indicates its readiness by sending a signal to PC server. The PC server downloads the next best-suited advertisement for that particular telephone user to the hardware. The hardware stores the advertisement in its memory and waits for a signal from the telephone exchange that the particular telephone user wants to hear an advertisement. The process is repeated in an endless cycle.

Communication Between the Hardware and the Server.

After storing the MP3 IDs in the User1, User2, User3, User4 databases, the PC software will send a signal to the hardware to inform the hardware that advertisements for user1 are ready to be recorded in hardware's memory.

After receiving the signal, the hardware (Tele exchange) will respond by sending a signal to the PC Server to inform that hardware is also ready for recording.

Then the application will send the first MP3 for first user from the User1 database to the hardware (Tele exchange) for recording.

The Server after sending the first MP3 will send a signal to the hardware (Tele Exchange) to inform the hardware, the advertisement MP3 is over and has completed recording. This will complete the process from PC software to send the advertisement related to user1.

The process is repeated for user2, user3 and user4. Now the hardware is ready to function as a telephone exchange with the ability to understand that a telephone user's request to play an advertisement and trigger the advertisement hardware accordingly.

When a telephone user, say user2 requests for an advertisement, by dialing ‘*’ first and the telephone number to which he wants to be connected, the telephone exchange will signal advertisement hardware that a request from telephone user 2 is received for advertisement, the advertisement circuit feeds an advertisement audio over the telephone user2. After completing the audio feed, the advertiser circuit informs the telephone exchange hardware that it can take over the telephone line for user2.

The telephone exchange will start the process of establishing connection between the telephone user2 and which ever number he has dialed.

Immediately after completing playing audio to a telephone user, the advertisement circuit signals PC server asking for next advertisement audio to be sent from PC for storing in its memory. The PC software selects the top most MP3 ID stored in user2 and sends a signal to advertisement circuit. The process of steps 2 to steps 4 is repeated.

Server notes the date and time of playing the advertisement to Telephone user 2 and updates the databases accordingly.

Then the server will update the details in the Transaction database.

I claim:

1. A method of providing advertisements through the telephones and mobile phones based on the approval of the call initiator during the set up of a call connection in a program controlled telephone exchange system/Mobile Switching Centre, comprising the following steps; storing in a memory the corresponding advertisement to the phone users based on their profiles; providing the advertisement feeds only on the approval of the phone call initiator; and providing the advertisement feeds over the phone when requested by the telephone exchange/Mobile Switching Centre characterized by;
(i) when callers calling to a number with “advertisement request code” before actual call process-instruct the exchange/Mobile Switching Center send message to advertising circuit, receives the message from the exchange, identify the caller and take a suitable advertisement from online/offline server to the caller via exchange/Mobile Switching Centre, the server is always connected to a particular internet website and take the caller profile and advertisement profile stored time to time, on completion of this process the exchange/Mobile Switching Centre will act actual call process;
(ii) Wherein the exchange will not alert advertising circuit, server and connect the actual call process without advertisement, when caller dialed the phone number without “advertisement request code”;
(iii) Online server input source is always connected to particular internet website and output source is always connected to the telephone exchange/Mobile Switching Centre.

2. The method as claimed in claim 1, wherein the exchange will not alert advertising circuit, server and connect the actual call process without advertisement, when caller dialed the phone number without “advertisement request code”, so that it would not disturb the caller.

3. The method as claimed in claim 1, wherein online server receives and updates the caller's profile and advertisement's profile, stored time to time variation for optional match.

5. The method as claimed in claim 1, the software and the embedded system that stores and retrieve the advertisement will analyze the performance and the allocation of the advertisements relayed, to calculate the benefits the advertising company and the phone user gain and the overall performance of this system towards the goal of better targeting the advertisement to the phone users.

8. The method as claimed in claim 1, wherein the caller dial “advertisement regular request ON code” one time to the exchange, the exchange received and register it and transmit the advertisement from the server regularly before the connecting the call without making “advertisement request code” every time he/she has calling.

9. The method as claimed in claim 1, wherein the caller dial “advertisement regular request OFF code” one time to the exchange, the exchange received and register it and connect the call directly without advertisement every time she/he has calling.

10. The method as claimed in claim 1, wherein the call initiator dial “Buying request code” after completion of the advertisement or in-between communicate to other terminal, then the exchange/Mobile Switching Centre send this request to register the caller details in advertiser's page via online server.

11. The method as claimed in claim 1, wherein the call initiator dial “repeat request code” after completion of the advertisement or in-between the communication to other terminal, then the exchange/Mobile Switching Centre transmits the same advertisement to the caller.
